(19) United States
(12) Patent Application Publication
(10) Pub. No.: US 2016/0323665 A1
(43) Pub. Date: Nov. 3, 2016

(54) Receiver Shock Mount Spine

(71) Applicant: Knowles Electronics, LLC, Itasca, IL (US)

(72) Inventor: Timothy Wickstrom, Elk Grove Village, IL (US)

(21) Appl. No.: 15/139,772

(22) Filed: Apr. 27, 2016

Related U.S. Application Data
(60) Provisional application No. 62/155,736, filed on May 1, 2015.

(51) Int. Cl. H04R 1/10; H04R 11/02; H04R 9/02

(52) U.S. Cl. CPC H04R 1/1066; H04R 1/1016; H04R 9/025; H04R 11/02

(57) ABSTRACT

An apparatus includes a receiver and a sound carrier. The receiver includes a housing with an opening, and produces sound energy that is emitted through the opening. The sound carrier is hollow and is coupled to the receiver over the opening. Sound energy that is emitted by the receiver traverses through the sound carrier. The sound carrier includes a stiffener that is disposed at only a first portion of the sound carrier causing the first portion to be resistant to movement. The stiffener resists free movement of the first portion of the sound carrier. A second portion of the sound carrier is free to move and absorb shock forces.

### CROSS-REFERENCE TO RELATED APPLICATION

This patent claims benefit under 35 U.S.C. §119(e) to U.S. Provisional Application No. 62/155,736 entitled “Receiver Shock Mount Spine” filed May 1, 2015, the content of which is incorporated herein by reference in its entirety.

### TECHNICAL FIELD

This disclosure relates to speakers or receivers and, more specifically, to shock protection approaches for these speakers or receivers.

### BACKGROUND

Different types of acoustic devices have been used through the years. One type of device is a speaker or receiver. In a speaker, an electrical signal is converted into sound energy. Using an electrical coil, magnets, and an armature, electrical current flowing through the electrical coil creates a changing electrical field with respect to the magnets. In this “balanced armature” approach, the changing electrical field moves the armature, which moves a drive rod, which, in turn, moves a diaphragm to create sound.

One problem associated with speakers is that they are subjected to forces and shock. For example, the speaker may be dropped or struck by some object. When these situations occur, the internal components of the speaker can become damaged or dislodged. If these components become damaged or dislodged, then the speaker may become completely inoperative or may not function properly. The user of the device in which the speaker is deployed may become frustrated since they can no longer use the device.

Various methods have been used in previous systems to prevent damage from shocks. However, these approaches are typically expensive to implement and/or do not work well in all circumstances.

The problems of previous approaches have resulted in some user dissatisfaction with these previous approaches.

### BRIEF DESCRIPTION OF THE DRAWINGS

For a more complete understanding of the disclosure, reference should be made to the following detailed description and accompanying drawings wherein:

FIG. 1 is a perspective view of a receiver with a sound tube;

FIG. 2 is a side cutaway view of the receiver and sound tube of FIG. 1;

FIG. 3 is a perspective view of the receiver and sound tube during initial phases of the assembly or manufacturing process;

FIG. 4 is a perspective view of the receiver with sound tube deployed in an ear shell.

Those of ordinary skill in the art will appreciate that elements in the figures are illustrated for simplicity and clarity. It will be further appreciated that certain actions and/or steps may be described or depicted in a particular order of occurrence while those of ordinary skill in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches describe speaker or receiver assemblies with improved shock protection and provide protection from mechanical shocks or forces from damaging or disabling the receiver. The approaches described herein are easy and cost effective to implement, and provide improved shock protection for speakers or receivers.

In many of these embodiments, a speaker assembly (including, for example, a diaphragm, magnets, coil, and yoke) is coupled to a sound tube or hollow sound carrier. A wire is attached to, coupled to, disposed in proximity to, or disposed along a first longitudinal length or portion of the tube so as to form a spine-like structure with the sound tube. The tube also includes a second longitudinal length or portion in which the wire is not disposed. The second portion (without the wire) is thus relatively free to move (compared to the first portion) so that the second portion can absorb energy. This arrangement allows the speaker assembly to be positioned in a variety of different positions, but still allows the speaker assembly to absorb shock energy. In other words, the wire is bendable and allows the speaker assembly to be positioned and dangle at different positions within some other structure. However, the arrangement still provides shock protection.

Advantageously, the present approaches provide versatile options to provide both positioning and shock protection for receivers disposed in other devices such as earphones. The present approaches also provide space savings and are adjustable to provide custom fits.

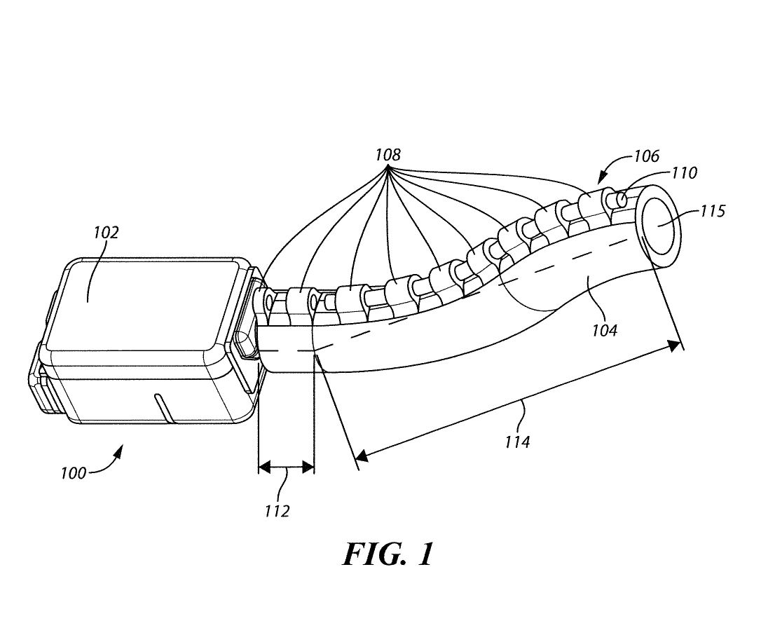

Referring now to FIG. 1, one example of a speaker apparatus 100 with improved shock protection is described. The receiver 100 includes a speaker assembly 102, and a sound tube (or carrier) 104. The sound tube 104 includes a spine 106. The spine 106 includes ears 108 and a wire 110. In some aspects, the wire 108 does not run through all the ears 108 thereby allowing the sound tube to have a floppy, unstiffened, unsupported portion 112, and a non-floppy, stiffened, and supported portion 114. The wire 110 may be a metal or plastic wire that is of such configuration so as to be bendable and provide enough strength to support the speaker assembly 102.

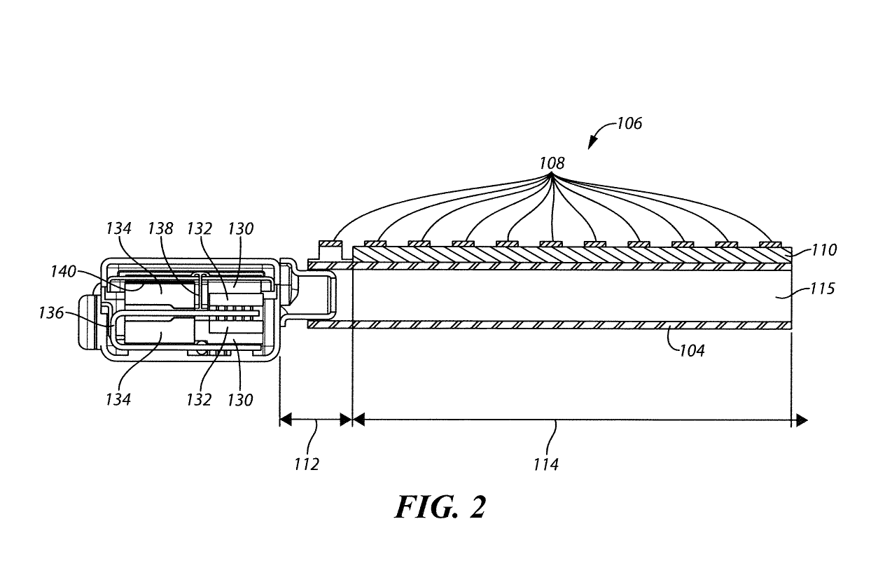

Referring now to FIG. 2, a cutaway view of the apparatus of FIG. 1 taken along a longitudinal axis is described. The same numbered parts refer to the same parts as shown in FIG. 1. In addition, the interior of the assembly 102 includes a yoke 130, magnets 132, a coil 134, an armature 136, a drive rod 138, and a diaphragm 140. This is a balanced armature design and it will be appreciated that this is one example of a speaker assembly and that other examples are possible.

In operation, an electrical current is received and this excites the coil 134. The excitation of the coil (with the magnets 132) provides a changing field that moves the armature 136, thereby moving the drive rod 138, and consequently moving the diaphragm 140. Movement of the diaphragm 140 produces sound that traverses the sound tube 104 and exits at the opening 115. The receiver assembly 100 (as will be discussed below) can be deployed in another device.

It will be appreciated that the portion 112 of the tube 104 is floppy and unsupported by the wire 110. Consequently, the portion 112 can absorb shocks and forces that are created when (for example) the assembly is dropped or subjected to an exterior force or forces. On the other hand, the stiffened portion 114 (with the wire 110) allows the assembly 100 to be custom-deployed within another device. In these regards and since the portion 114 is relatively stiff (i.e., the portion 114 can support the speaker assembly 102 without significant bending or movement), the portion 114 can be bent or adjusted (thereby adjusting the position of the assembly 102). In this way, the position of the assembly 102 can be adjusted and fixed within another device such as an earphone. So configured, the assembly 102 can be moved into a variety of different positions within, for example, an earphone shell (or housing).

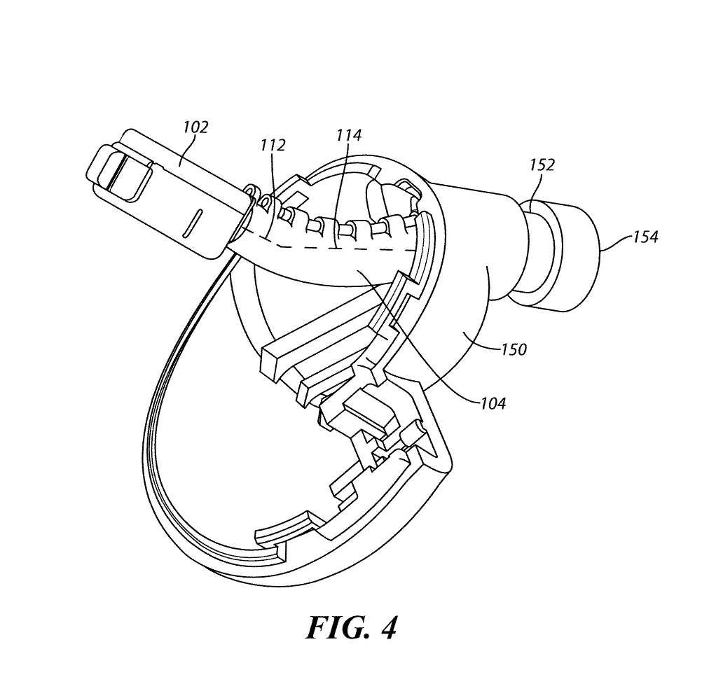

In some aspects, adhesive is used to attach the tube 104 both at the receiver end (to the assembly 102) and at the end that attaches to the earphone (as shown below with respect to FIG. 4 when the device is disposed in an ear phone). When a metal wire is used, a metal wire type is chosen that is position-able (i.e., holds its shape). It is also possible to use a non-position-able wire that provides the shape and stiffness needed.

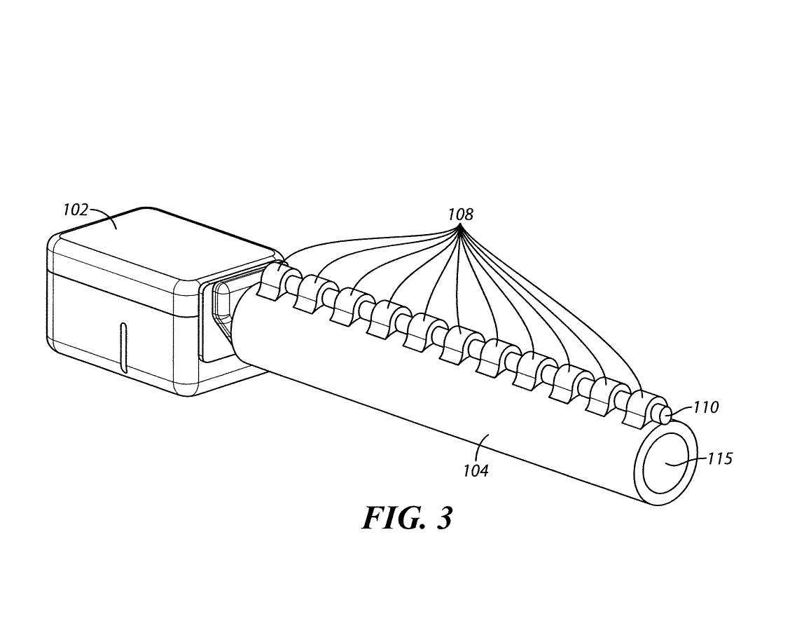

Referring now to FIG. 3, one example of the early stages of constructing the apparatus shown in FIG. 1 and FIG. 2 is described. As shown in FIG. 1, FIG. 2, and FIG. 3, the piece part is the molded tube 104 with over-molded ears 108 over the bendable wire 110. It will be appreciated that the spine 106 may be deployed on one side of the tube 104 or there may be multiple spines deployed on more than one side of the tube 104.

As shown in FIG. 3 (an early stage in the manufacturing process), the wire 110 is initially placed through all the ears 108. This figure shows the assembly after the parts have been molded.

As mentioned, the ears 108 and tube 104 may be formed around the wire 110 with the wire 110 being deployed along the entire length of the tube 104. At this point, the wire 110 may overhang the sides of the tube 104 and then be trimmed to the correct length. The next step is to shape and remove the wire section to produce the device shown in FIG. 1. In these regards, the ends of the wire 110 may be snipped or cut to the correct length. The wire 110 may first be pulled out to define the unsupported portion 112 of the tube 104.

Referring now to FIG. 4, one example of the deployment of the device of FIG. 1 and FIG. 2 within another device or assembly is described. The assembly 100 (including the speaker assembly 102 and sound tube 104) is deployed within an earphone shell (or housing) 150 having a sound tube 152. The end of the sound tube 104 may be secured (e.g., cemented) to an end 154 of the sound tube 152.

It will be appreciated that the portion 112 of the tube 104 is floppy and unsupported by the wire 110. Consequently, the portion 112 can absorb shocks and forces that are created when (for example) the earphone shell 150 is dropped or subjected to an exterior force.

On the other hand the stiffened portion 114 (with the wire 110) allows the assembly 100 to be custom-deployed within the earphone shell 150. In these regards and since the portion 114 is relatively stiff (i.e., the portion 114 can support the speaker assembly 102 without significant bending or movement), the portion 114 can be bent or adjusted (thereby adjusting the position of the assembly 102). In this way, the position of the assembly 102 can be adjusted and fixed within the earphone 150.

It will be appreciated that although the assembly 100 is shown as being deployed within an earphone shell, the assembly can be deployed in various other types of devices and achieve the same advantages.

Preferred embodiments of this disclosure are described herein, including the best mode known to the inventor(s). It should be understood that the illustrated embodiments are exemplary only, and should not be taken as limiting the scope of the appended claims.

What is claimed is:

1. An acoustic apparatus comprising:
a receiver with a housing including an opening through which sound energy produced by the receiver is emitted;
a flexible sound conducting carrier having an axial dimension, the sound conducting carrier having a first end portion and a second end portion opposite the first end portion, the first end portion of the sound conducting carrier coupled to the opening of the receiver, wherein sound energy emitted through the receiver opening traverses the sound conducting carrier;
a stiffener disposed along a portion of the axial dimension of and fastened to the sound conducting carrier,
the portion of the sound conducting carrier along which the stiffener is disposed being more rigid than a portion of the sound conducting carrier along which the stiffener is not disposed.

2. The acoustic apparatus of claim 1, wherein the stiffener comprises a rod, and the sound conducting carrier comprises an elongated tube with a plurality of fastening members disposed along at least a portion of the axial dimension of the tube, the plurality of fastening members each having an aperture through which the rod is disposed.

3. The acoustic apparatus of claim 1, wherein the stiffener comprises a flexible rod with a configurable shape, wherein the portion of the sound conducting carrier along which the stiffener is disposed is flexible and assumes the shape of the flexible rod.

4. The acoustic apparatus of claim 3 further comprising one or more fasteners interconnecting the flexible rod to the sound conducting carrier.

5. The acoustic apparatus of claim 3, wherein the sound conducting carrier comprises an elongated tube with a plurality of ears disposed along the axial dimension of the tube, the plurality of ears each having an aperture through which the rod is disposed.

6. The acoustic apparatus of claim 1, wherein the receiver is a balanced armature receiver.

7. The acoustic apparatus of claim 1, further comprising an outer housing disposed about the receiver and the sound conducting carrier, the outer housing having a sound port coupled to the second end portion of the sound conducting carrier.

8. The acoustic apparatus of claim 7, wherein the sound conducting carrier is an elongated member configured to fit within the outer housing by bending the stiffener, wherein the portion of the sound conducting carrier along which the stiffener is not disposed absorbs shock forces applied to the acoustic apparatus.

9. An acoustic receiver sound conducting apparatus comprising:
a flexible sound carrier having an elongated sound conducting passage with an axial dimension, the sound carrier having a sound-input end portion and a sound-output end portion opposite the sound-input end portion,
wherein sound can traverse the sound conducting passage of the sound carrier from the sound-input end portion toward the sound-output end portion;
an elongated stiffener fastened to the sound carrier along a portion of the axial dimension of the sound carrier,
the stiffener being flexible and having a configurable shape, wherein the portion of the sound carrier along which the stiffener is disposed assumes a shape of the stiffener,
the portion of the sound carrier along which the stiffener is disposed being more rigid than a portion of the sound carrier along which the elongated stiffener is not disposed,
wherein the portion of the sound carrier along which the elongated stiffener is not disposed absorbs shock forces applied to the acoustic apparatus.

10. The apparatus of claim 9, wherein the stiffener comprises a rod, and the sound carrier comprises a plurality of fastening members disposed along at least a portion of the axial dimension of the tube, the plurality of fastening members interconnecting the rod and the sound carrier.

11. The apparatus of claim 9, the sound carrier and the plurality of fasteners constitute a unitary member.

12. The apparatus of claim 11, wherein the stiffener comprises a wire.

13. The assembly of claim 11, wherein the stiffener comprises a plastic rod.

14. The assembly of claim 9, wherein the stiffener comprises a rod and the sound carrier comprises a plurality of ears disposed along at least a portion of the axial dimension of the sound carrier, the plurality of ears each having an aperture through which the rod is disposed.

15. An acoustic apparatus comprising:
a balanced armature receiver with a housing including an opening through which sound energy produced by the balanced armature receiver is emitted;
a flexible sound tube having an axial dimension, the sound tube having a first end portion and a second end portion opposite the first end portion, the first end portion of the sound tube coupled to the opening of the receiver;
an elongated and pliable stiffener disposed along a portion of the axial dimension of the sound tube and fastened to the sound tube, the portion of the sound tube along which the stiffener is disposed being more rigid than a portion of the sound tube along which the stiffener is not disposed;
an outer housing having a sound output port, the balanced armature receiver and the sound tube disposed within the outer housing, the second end portion of the sound tube coupled to the sound output port of the outer housing,
wherein sound energy emitted through the receiver opening passes through the sound tube and out the sound output port of the outer housing.

16. The acoustic apparatus of claim 15, the stiffener comprises a flexible rod with a configurable shape, the portion of the sound tube along which the stiffener is disposed is flexible and assumes a shape of the flexible rod, wherein the shape of the stiffener is configured so that the balanced armature receiver and sound tube fit within the outer housing.

17. The acoustic apparatus of claim 16, the sound tube comprises an elongated member having a plurality of ears disposed along the axial dimension of the sound tube, the plurality of ears each having an aperture through which the flexible rod is disposed.

18. The acoustic apparatus of claim 15, wherein the sound tube is an elongated member configured by a shape of the stiffener to fit within the outer housing, wherein a portion of the sound tube along which the stiffener is not disposed absorbs shock forces applied to the acoustic apparatus.

19. The acoustic apparatus of claim 15 further comprising one or more fasteners that fasten the flexible rod to the sound tube.

20. The acoustic apparatus of claim 15, wherein outer housing is configured to fit adjacent to or partially within a user's ear canal.
